(19) United States
(12) Patent Application Publication
(10) Pub. No.: US 2012/0154521 A1
(43) Pub. Date: Jun. 21, 2012

(54) 360-DEGREE CAMERA HEAD FOR UNMANNED SURFACE SEA VEHICLE

(76) Inventors: Julie A. Townsend, Pasadena, CA (US); Reginald G. Willson, Eagle Rock, CA (US); Michael S. Garrett, Castaic, CA (US); Charles F. Bergh, Thousand Oaks, CA (US); Eric A. Kulczycki, Sierra Madre, CA (US); Terrance Huntsberger, Altadena, CA (US); Ashitey Trebi-Ollennu, Pasadena, CA (US)

(21) Appl. No.: 13/281,683

(22) Filed: Oct. 26, 2011

Related U.S. Application Data
(60) Provisional application No. 61/406,881, filed on Oct. 26, 2010.

(51) Int. Cl. H04N 5/225

(52) U.S. Cl. 348/36; 348/E05.026

(57) ABSTRACT

A camera head for use in a marine environment having a cylindrical watertight housing, top and bottom plate members closing the cylindrical housing, and a plurality of ports through the vertical wall of the housing and positioned at a regular angular intervals. A transparent pane is sealed over each port, retained in place by compression against a gasket or O-ring by a compression member. A corresponding plurality of cameras are fixedly positioned behind the ports and the angular field of view of each camera is selected to be greater than the angular interval between the ports such that a continuous 360-degree view of the marine environment is always visible. Six 72-degree FOV cameras spaced at regular 60-degree intervals are preferred. The housing contains cooling/ventilation as well as power and image processing and control systems so as to be self contained.

### CROSS-REFERENCE TO RELATED APPLICATIONS

The present application claims priority to U.S. provisional patent application Ser. No. 61/406,881 filed Oct. 26, 2010 that is incorporated herein by reference.

### STATEMENT OF GOVERNMENT RIGHTS

This invention was made with government support under funding project N0001411IP20042 awarded by the United States Navy. The government has certain rights in the invention.

### BACKGROUND OF THE INVENTION

1. Field of the Invention

The present invention relates to visual sensing systems for autonomous control of an unmanned sea surface vehicle (USSV) and, more specifically, to a watertight camera head for providing a 360-degree view of a vehicle's surroundings.

2. Description of the Background

Unmanned vehicles are increasingly among the systems available to commercial enterprise and the military for surveillance, monitoring and patrol of areas by land, sea and air. Unmanned vehicles may be remotely operated in real time via robust and high speed communications systems or, in some situations, may operate autonomously. Autonomous vehicle operation requires a control system that is aware of its surroundings in order to navigate to and between fixed points, to avoid collisions with objects that may come into their path, and to identify and react to objects of interest. Recent advances in computing and machine vision have made it possible for a computer controlled and automated system to “see” its surroundings using optical sensing devices such as digital video cameras.

Autonomous navigation and control of USSV's presents a significant challenge. A visual sensing system for a USSV must provide a 360-degree view from the deck of the sea surface vehicle in order to maintain total situational awareness. However, a deck mounted visual sensing system, including both optics and electronics, is inevitably subjected to the most excruciating conditions during operation including inclement weather, corrosive sea spray, constant motion and acceleration and repeated mechanical shock. Past optical sensor systems have employed a fixed camera position on the vehicle and have pointed the camera at an object of interest by reorienting the entire vehicle. Such systems are inherently prone to significant blind spots, slow reaction times and inefficient operation. Actuated systems have also been employed that point the camera at an object of interest without the need to reorient the entire vessel. However, such systems have a limited field of view at any given time and are prone to wear and failure of their mechanical systems due to the constant motion, shock and environmental exposure.

What is needed is a low cost, easily manufacturable, watertight, and mechanically robust sensing system capable of continuously capturing a 360-degree field of view. Such a system should have a minimum of moving parts and should provide a self contained, climate controlled operating environment in which on or more optical sensors can view the vehicles surroundings.

### SUMMARY OF THE INVENTION

It is, therefore, an object of the present invention to provide a camera head that provides a substantially uninterrupted 360-degree view for use on surface sea vehicles.

It is another object of the present invention to provide a camera head that is impervious to weather and sea spray.

It is yet another object of the present invention to provide a camera head that is rugged so as to be unaffected by constant motion, acceleration and repeated shock.

And it is another object of the present invention to provide a camera head that maintains an internal climate controlled condition.

According to the present invention, the above-described and other objects are accomplished by a camera head for use in a marine environment comprising a watertight housing having a continuous vertical surface, preferably circular, defining a perimeter and enclosing a generally cylindrical volume. A plurality of viewing ports are provided through the vertical surface preferably positioned at a regular angular intervals about a circumference of the housing. A corresponding plurality of cameras are fixedly positioned behind the viewing ports. A transparent element is sealed in position over each port and is preferably retained in place by compression against a gasket or o-ring by a compression member. The angular field of view of each camera is selected to be greater than the angular interval between the ports such that a continuous 360-degree view of the marine environment is always attained. For example, in one embodiment six 72-degree FOV cameras spaced at regular 60-degree intervals are provided. The housing contains ventilation and climate control systems as well as power and image processing and control systems so as to be self contained.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a side view of a camera head according to the present invention.

FIG. 2 is a perspective view of a camera head according to the present invention from above with the top panel removed.

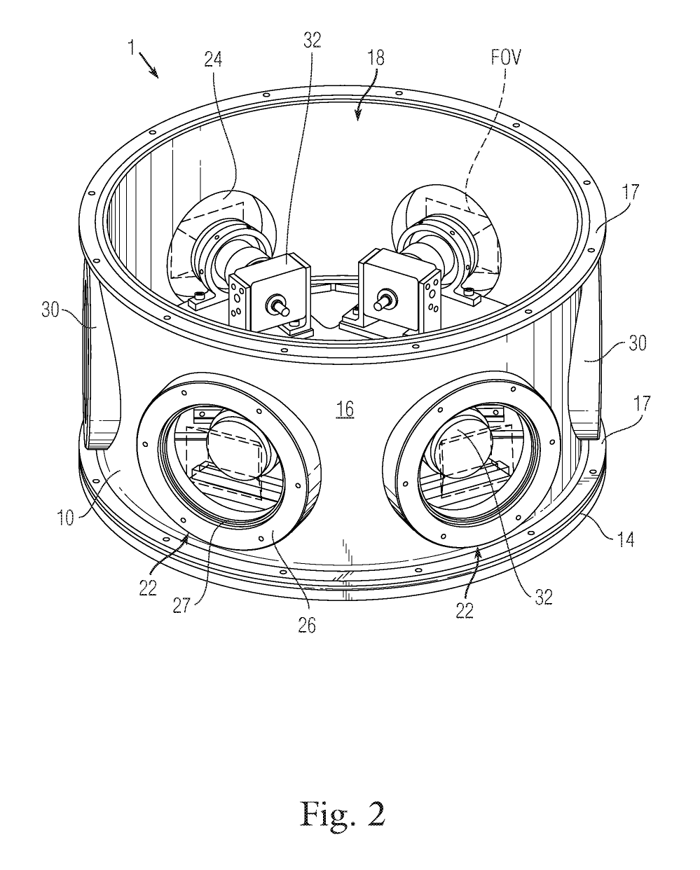

FIG. 3 is a perspective section view of a camera head according to the present invention with the top panel removed.

FIG. 4 is a plan view of a camera head according to the present invention with the top panel removed.

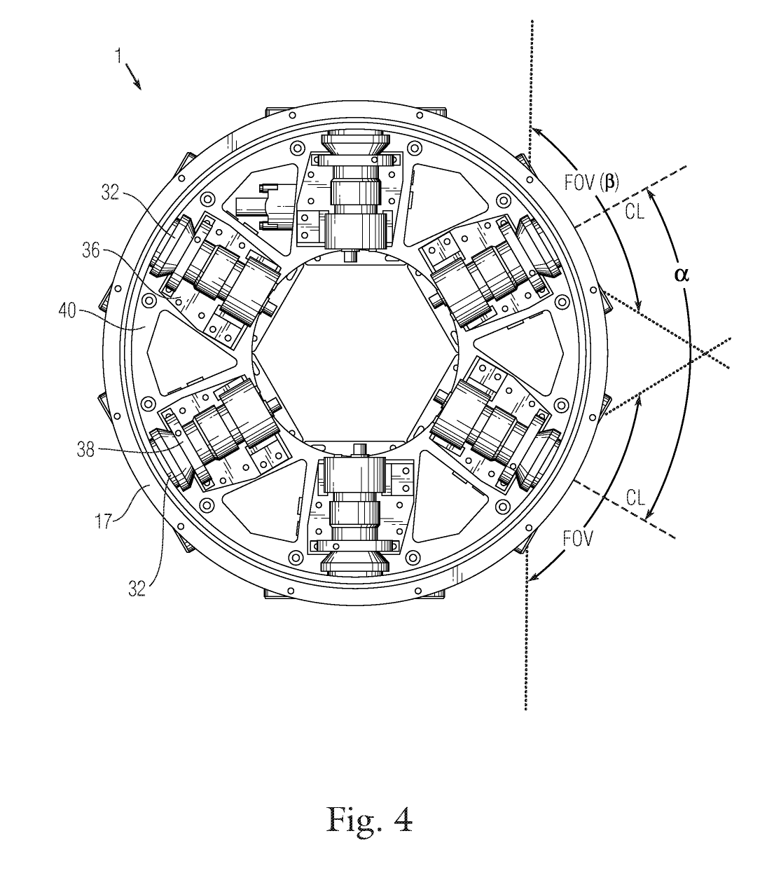

### DETAILED DESCRIPTION OF THE PREFERRED EMBODIMENT

The present invention discloses a 360-degree camera head suitable for use in harsh marine environments to provide a continuous, 360-degree field of view for control and navigation of a vessel. The camera head incorporates a sealed, climate controlled housing having multiple ports through which optical sensors (i.e., cameras in a preferred embodiment) may be positioned with overlapping fields of view in order to provide total 360 degree situational awareness.

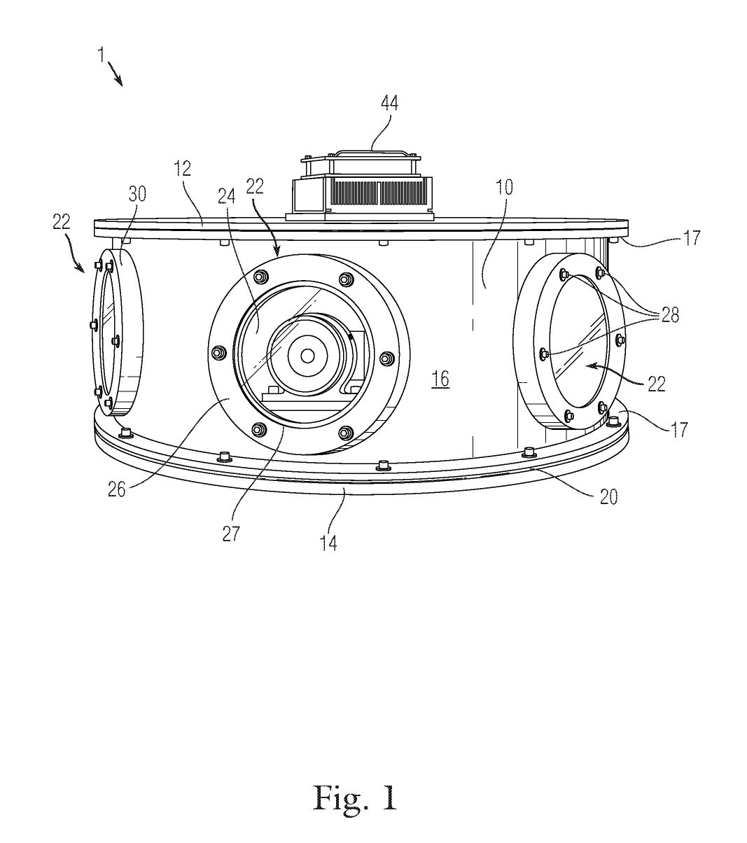

With reference to FIG. 1, the camera head 1 includes a housing 10 constructed from a strong, water impervious material such as steel, aluminum or fiber composite. The housing 10 preferably has a circular top and bottom panel 12, 14, respectively, that are attached to a hollow cylindrical body 16 defined by vertical sidewalls. The diameter of the cylindrical body 16 of the preferred embodiment is preferably from 16 to 24 inches and most preferably 20 inches. It should be noted that terms describing the relative orientation (e.g., vertical, horizontal, etc.) or position (e.g., top, bottom, etc.) are used herein with reference to the embodiment(s) depicted in the included figures and are not meant to limit the invention as it might be deployed in actual operation. The sidewalls of cylindrical body 16, while preferably vertical, may alternatively be provided in a sloped orientation either inward or outward to, for example, provide an overhanging top element 12 for protection of the ports as will be described or to provide a raked profile for reduced aerodynamic\fluidic resistance. It is sufficient that the sidewalls 16 provide a vertical dimension between the upper and lower panels 12, 14 so as to define an enclosed volume there between. One of the upper and lower panels 12, 14 may be integrally attached to (or formed with) the sidewalls of body 16, and one or both are removably attached and sealed to the sidewalls as will be described. Sealing of the upper and/or lower panels 12, 14 may be by compression of a gasket or O-ring 20 between the upper/lower panel and the sidewalls of body 16. An annular flange 17 may be provided for this purpose about the upper and/or lower ends of the sidewalls of body 16 to facilitate compression of a gasket and joining of the sidewalls to the upper and lower panels 12, 14.

The sidewalls of body 16 preferably form a circular cross-section, interrupted by ports 22, and generally bounding a cylindrical volume. Where rakes or sloped sidewalls are employed the enclosed volume may be a conical frustum. Alternate embodiments of the present invention include sidewalls bounding a square, preferably regular pentagonal, hexagonal or other closed-symmetric geometric form. As will be described, the radial distribution of ports 22 will be a function of the shape of the included volume and the horizontal field of view of the camera or optical sensor employed.

A series of ports 22 though the sidewalls of body 16 are preferably positioned at regular angular intervals (a) about the central axis of body 16. In a preferred embodiment six ports 22 are provided such that the radial centerlines (CL) of ports 22 are regularly spaced at 60-degree angular intervals (α) about the central axis of body 16. Where a non-circular housing is employed the number of ports 22 will preferably correspond to the number of segments in the sidewalls of body 16 (e.g. a pentagonal housing would have five ports at 72-degree angular intervals α). The ports 22 are preferably, but not necessarily, oriented such that their radial centerlines are coplanar. The ports 22 are preferably circular to provide a circular field of view, and are fronted by a conforming compression ring 26 to provide even compression of a transparent optical pane 24 about its perimeter as will be described. It should be noted that a non-circular ports having angular peripheries (e.g. square) would provide uneven compression of the optical pane 24 and are thus prone to leaking.

Each port 22 is completely covered by optical pane 24, the latter being sized and shaped to cover the opening of the port 22. Each optical pane 24 is sealed by a grommet or O-ring 27 encircling the port and held in place by compression ring 26 that sandwiches the pane 24 against grommet/O-ring 27, such that the ports 22 are watertight. The compression ring 26 is affixed to the housing 10 by a series of screws 28 threaded into the outside surface of the housing 10. The optical pane 24 is preferably a flat transparent pane or lens, preferably made of tempered or laminated glass or a highly transparent, high strength polymer such as acrylic (plexiglass). In certain alternate embodiments the optical pane 24 may be polarized. In certain other alternate embodiments the optical pane may provide partial or full UV filtration. In certain other alternate embodiments the optical plane may be made of germanium oxide, sapphire, AMTIR (Amorphous Material Transmitting IR), or some other material that is transparent for infrared sensing. Where, as in the preferred embodiment, the optical pane 24 is a flat planar panel and the body 16 of the housing 10 is circular, each port 22 is elevated by a stub 30 encircling each port 22 in sealed engagement with the body 16. The stubs 30 are saddle-shaped proximal to the housing 10 so as to conform to the circular shape and may be integrally formed therewith or attached such as by welding. The stub 30 extends radially a distance outward from body 16 sufficient to allow the distal end of each stub 30 to terminate in a single plane, thereby providing a surface to which the optical pane 24 may be sealed by compression as described. The terminal plane of the stub 30 may itself be truly vertically oriented as depicted or may be sloped or raked irrespective if the orientation of the surface of the housing 10. No stub 30 is required where a polygonal body 16 is utilized and the ports 22 are positioned within the flat surface segments of the polygonal body 16.

A video camera system is mounted within the volume 18 of the housing 10. The camera system comprises a network-enabled plurality of color video cameras each utilizing a CMOS or similar image sensor, or other sensing modalities such as infrared in the long-wave, mid-wave, or short-wave ranges. For example, given six (6) ports 22, six (6) 1.3 Megapixel CMOS image-sensor cameras 32 may be used, each having an output resolution of 1280×1024 pixels per image for a total of 7680×6144 pixels. The camera system produces panoramic video images by synchronizing the six image sensors and fusing the output of the image sensors into a stitched 360° field of view. Each color (or other sensing modality) camera 32 is fixedly positioned such that it collects an image through one of the ports 22. The cameras 32 are preferably radially positioned within the housing 10 (i.e., such that their horizontal field of view is centered on a radius of the housing through the centerline of the port 22 through which the camera 32 is pointed). The cameras 32 are selected so as to have a horizontal angular field-of-view (FOV) (β) that exceeds the angular spacing of the ports 22 about the housing 10. For example, where, as in the depicted embodiment, six cameras 32 are positioned at 60-degree intervals, the horizontal angular field-of-view β of each camera must exceed 60-degrees such that the areal fields of view overlap very near to the housing and/or vessel and preferably at a distance less than any distance between the housing 10 and the perimeter of the vessel hull such that the entire environment in which the vessel is operating is always visible within the field of view of at least one camera 32. Six 72-degree FOV cameras spaced at regular 60-degree intervals are preferred.

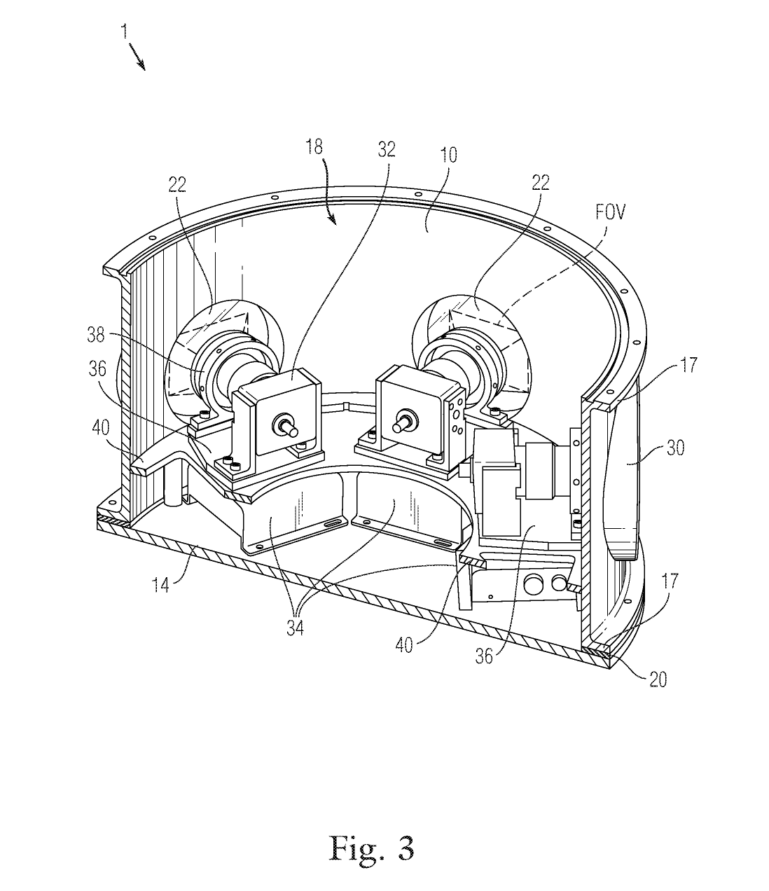

Also within the volume 18 of the housing 10 are the imaging support electronics 34 and a power distribution system (not seen) for the cameras 32. As seen in FIG. 3, in a preferred embodiment each camera 32 is mounted to a base plate 36 having a circular lens stabilization ring 38 engaged to the base plate and encircling the lens of the camera 32 to ensure the lens remains fixed during operation of the vessel. A perforated shelf ring 40 is horizontally mounted within the housing 10, and the camera base plates 32 are mounted on the shelf ring 40 so as to be in vertical alignment with the ports 22. Shelf ring 40 is preferably formed with a series of perforations or cut-outs corresponding to the number of cameras 32 such that the signal cabling of the camera may be routed to the support electronics 34. The lower plate member 14 is provided with one or more openings through which image signal and power cabling may sealingly pass to carry power to the cameras 32 by way of the power distribution panel and carry an imaging signal from each camera to a remote control system for image integration and analysis. The camera 32 and support electronics 34 are confined to the outer perimeter of the cylindrical housing 10 to permit proper cooling and air circulation as will be described.

To prevent internal damage due to condensation, freezing, or excessive heat, and to reduce the amount of time needed for the camera head and cameras 32 to reach equilibrium within the optimal thermal operating range, the watertight housing 10 is also equipped with an environmental control system (FIG. 1). The system functions automatically and continuously when powered, while in use or in storage, independent of any other system or power in the camera housing. The solid state heat pump includes an externally exposed radiator 44 with internal and external fans (not visible) for circulation. The heat pump may be a commercially available Thermo-Electric Cooler (TEC, or Peltier effect) unit with waterproof fan panel-mounted in the upper panel 12, and aforementioned fans may be mounted inside the camera head to promote air flow as desired. The upper plate is provided with an opening through which the radiator 44 is sealingly inserted. The upper panel opening may be sealed to the radiator by compression of a closed cell neoprene foam gasket or by any other means known in the art to prevent water and air intrusion into the head 1. The heat pump may be used for heating but is typically used for cooling and dehumidification, with electric heaters placed inside the camera head to maintain temperature when needed. Dehumidification is achieved by keeping one side of a Thermo-Electric Cooler (TEC) colder than any other internal component, and a metallic fiber wick guides the condensate from the drip pan out through a small vent hole in the bottom of the housing into an external drain tube that protects the wick from contaminants. Preferably, a fabric or wire mesh wick leads from the heat pump to a small drain pan in the floor of the housing from which where a metal fiber wick leads to the outside such that the condensed moisture drips off the pointed end. To protect against wicking splashed contaminants into the housing, a tube encloses the wick and extends past the end by a short distance. The vent hole also provides a single access point to control the effects of the air and moisture that will inevitably enter due to constant changes in air pressure, temperature, and humidity. One skilled in the art will appreciate that additional solid state heat pumps may be added along the surface of the camera housing as required, with or without an opening in the camera housing, also that an external liquid based heat pump may be used in conjunction with a TEC dehumidifier should operating conditions mandate added capacity over ruggedness and stand-alone capability.

It should now be apparent that the above-described camera head provides a substantially uninterrupted 360-degree view, and yet is well-suited for surface sea vehicles because it is impervious to weather and sea spray, and is rugged and resistant to constant motion, acceleration and repeated shock.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

What is claimed:

1. A camera head for use in a marine environment, comprising
a watertight housing, said housing having a continuous vertical surface defining a perimeter and enclosing a volume;
a plurality of ports through said vertical surface, said ports positioned at a regular angular interval and each having a transparent panel sealingly engaged there over;
a plurality of cameras radially mounted within said volume such that one of said plurality of cameras is positioned to capture an image through each of said ports, each camera of said plurality having a horizontal angular field of view greater than said angular interval.

2. The camera head of claim 1 wherein said perimeter is a polygon selected from the group consisting of a square, a pentagon, a hexagon, a heptagon and an octagon.

3. The camera head of claim 1 wherein said perimeter is circular.

4. The camera head of claim 3 wherein said plurality of ports is six ports and said angular interval is 72 degrees.

5. The camera head of claim 3 further comprising a top member engaged to one end of said vertical surface and a bottom member sealingly engaged to another end of said vertical surface such that said housing is substantially in the form of a closed cylinder.

6. The camera head of claim 3 further comprising a stub completely encircling each of said plurality of ports and sealingly engaged to said vertical surface, each of said stubs extending radially from said housing and terminating at a distal end in a single plane, said transparent panel sealingly engaged to said distal end.

7. The camera head of claim 1 further comprising a resilient member encircling each of said ports and between said vertical surface and said transparent panel, said transparent panel sealingly compressed against said resilient member by a compression ring.

8. The camera head of claim 7 wherein said compression ring is engaged to said housing by a plurality of screws.

9. The camera head of claim 1 wherein said volume is ventilated.

10. The camera head of claim 1 further comprising at least one fan situated within said volume for air circulation.

11. The camera head of claim 1 wherein said volume is climate controlled.

12. The camera head of claim 1 wherein said transparent panel is polarized.

13. The camera head of claim 1 wherein said transparent panel is an ultraviolet filter.
